(19) United States
(12) Patent Application Publication
(10) Pub. No.: US 2026/0221752 A1
(43) Pub. Date: Jul. 30, 2026

(54) SWITCHING DEVICE

(71) Applicant: Ellenberger & Poensgen GmbH, Altdorf (DE)

(72) Inventors: Manuel ENGEWALD, Nuernberg (DE); Alexander LABS, Winkelhaid (DE); Markus MIKLIS, Pfeifferhuette/Schwarzenbruck (DE); Hendrik-Christian KOEPF, Nuernberg (DE)

(73) Assignee: Ellenberger & Poensgen GmbH, Altdorf (DE)

(21) Appl. No.: 19/460,790

(22) Filed: Jan. 27, 2026

(30) Foreign Application Priority Data
Jan. 27, 2025 (DE) 10 2025 102 798.6

(51) Int. Cl. H02H 3/08; H02H 3/05

(52) U.S. Cl. CPC H02H 3/08; H02H 3/05

(57) ABSTRACT

A switching device that is designed for a nominal current, and that includes two terminals that are electrically connected via a first current path and a second current path that are electrically connected in series. The first current path has a mechanical switch and the second current path has a semiconductor switch. The mechanical switch is driven with a drive having a first drive unit that is energized with a control unit, and having a second drive unit connected in parallel to the second current path. The switching device is designed in such a way that the mechanical switch is transferred into an open state when a predetermined electrical current that is less than three times the nominal current is conducted by means of the second drive unit. The invention further relates to a method for operating a switching device.

This nonprovisional application claims priority under 35 U.S.C. § 119(a) to German Patent Application No. 10 2025 102 798.6, which was filed in Germany on January 27, 2025, and which is herein incorporated by reference.

### BACKGROUND OF THE INVENTION

### Field of the Invention

The invention relates to a switching device and to a method for operating a switching device. The switching device in each case includes two terminals that are electrically connected via a first current path and a second current path.

### Description of the Background Art

Circuit breakers are generally used to protect an electrical line or a device in the event of a malfunction of the associated circuit, for example an excessive applied voltage or an excessive flow of electrical current, which occurs, for example, when there is prior damage to the device or electrical line to be protected. In this case, the current flow is interrupted by means of the circuit breaker, thus avoiding further damage.

The circuit breaker has a switch for interrupting the current flow. The circuit breaker thus represents one design of a switching device. For provision of contact protection and ease of installation, the switch is situated inside a housing. The switch is designed as a semiconductor switch, for example. Galvanic separation is not possible by use of the semiconductor switch. Alternatively, the switch therefore has a mechanical design and is in operative connection with a drive which includes an electromagnet, for example. It is thus possible to change the switching state of the switch by energizing the drive.

If the switch has a defect during operation, it is no longer possible for the circuit breaker to interrupt the electrical current, as a result of which functionality is no longer provided by means of the circuit breaker. To increase safety, it is therefore known to electrically connect two switches in series. Thus, even if there is a defect in one of the switches, the other switch can be used to interrupt the electrical current flow. If a galvanic separation is necessary at all times for safety reasons, two mechanical switches must be provided, which excessively increases the installation size and also the weight. In order to achieve functional safety, the two switches must be based on different technologies, which complicates the design and increases manufacturing costs.

### SUMMARY OF THE INVENTION

It is therefore an object of the present invention to provide a particularly suitable switching device and a particularly suitable method for operating a switching device, while advantageously reducing manufacturing costs and/or increasing safety.

The switching device is used, for example, to switch an electrical current, in particular to create and/or interrupt an electrical current flow. For this purpose the switching device advantageously has two states, namely, an electrically conductive state, which is also referred to as a closed state. In this case it is possible to conduct the electrical current by means of the switching device. For the other state, which is referred to as an open or electrically nonconductive state, in particular flow of electrical current flow across the switching device is not possible. For example, the switching device is manually actuated/actuatable, so that the switching device is a manual switch. Alternatively or in combination therewith, it is possible, for example, to electrically actuate the switching device, and thus in particular remotely. In another alternative, the switching device is automatically actuated, for example, advantageously as a function of certain conditions.

The switching device is suitably an integral part of a circuit breaker or of a contactor. The circuit breaker is used, for example, to protect a device, and the circuit breaker is a device circuit breaker, for example. Alternatively or in combination therewith, the circuit breaker can be used to protect a line and is thus a line circuit breaker. In particular, the circuit breaker can be used in a direct voltage circuit, for example between a load and a direct voltage source or the like, so that in particular a circuit is formed. A direct voltage between 400 V and 650 V, i.e., a particularly high direct voltage, is preferably present in the direct voltage circuit. The circuit breaker for protecting an actuator is preferably used in an industrial facility, with the actuator in particular forming the load. The circuit breaker or at least the switching device is advantageously used in the field of industrial automation. In particular, the voltage switched by means of the circuit breaker/switching device is 24 V, 48 V, 380 V, 650 V, 760 V. In one alternative, the circuit breaker is used to protect street lighting, a ship electrical system, infrastructure for railway applications, drives for railway applications, or in the field of electrified aviation. In a further alternative, the circuit breaker/switching device is used in the development and integration of renewable energy generators, in stand-alone electrical grids, for private and domestic use, in greenhouses, in the electrification of road transport vehicles (electromobility), in agriculture, or for construction vehicles. The (direct) voltage used is between 1500 V and 3000 V, for example, or is 110 V, 380 V, 400 V, 800 V, 1000 V, 1500 V, or 3000 V. In summary, as an alternative to use for an industrial facility, the circuit breaker/switching device is used, for example, in an electric vehicle, such as a motor vehicle, an aircraft, or a ship/boat.

The switching device can be designed, for example, as an isolating switch, also referred to as an isolator. For example, the switching device includes a mechanical level by means of which the switching state of the switching device may be changed.

The switching device can include two terminals, to which further components of the circuit, advantageously lines that may be present, are connected in the installed state. The terminals are suited, in particular provided and configured, for this purpose. A cable or a busbar is preferably connected to the particular terminal, and has a cross section, for example, between 10 mm2 and 100 mm2 or between 25 mm2 and 92 mm2. The cross section is 16 mm2, 25 mm2, or 35 mm2, for example. The cross section is, for example, 6 mm2, between 6 mm2 and 16 mm2, or between 16 mm2 and 50 mm2. In particular, the terminals are designed in the manner of cage clamps or at least include same.

The two terminals can be electrically connected to one another via a first and a second current path. The first and the second current paths are electrically connected in series. For example, for electrically connecting the two terminals, only the first and the second current paths are present/sufficient. Alternatively, a further current path may be electrically connected in series with this series connection. In summary, when an electrical current is conducted by means of the switching device, the electrical current is conducted via the first and second current paths, at least during normal operation.

The first current path can have a mechanical switch, so that it is electrically connected between the two terminals of the switching device. It is thus possible to switch the electrical current flow across the switching device by means of the mechanical switch. The mechanical switch is suitably situated in a housing that is preferably made of a plastic. Contact protection for the mechanical switch is thus provided, and the mechanical switch is also protected from environmental influences. Terminals that are possibly present are advantageously introduced into the housing, thus enabling electrical contacting of the two current paths from outside the housing.

The mechanical switch can have a location for interrupting the electrical current, having a movable contact with which a fixed contact is associated. It is possible to move the movable contact relative to the fixed contact, and in particular to place them next to one another and also to space them apart from one another. When the movable contact rests against the fixed contact, the mechanical switch is electrically conductive, so that the electrical current can be conducted across the mechanical switch. In contrast, if the movable contact is spaced apart from the fixed contact, in particular an air gap is formed between them, or at least the mechanical switch is then open and therefore electrically nonconductive.

The mechanical switch can have, for example, only one location for interruption. However, the mechanical switch is particularly preferably designed as a double interrupter and therefore includes two movable contacts, with each of which a fixed contact is associated. For this purpose, the mechanical switch advantageously includes a contact bridge that is movably supported. The contact bridge in particular is supported so that it is transversely movable, and in particular one of the movable contacts is situated in each case at the opposite ends.

The switching device also can include a semiconductor switch, which is an integral part of the second current path and is thus electrically connected in series with the mechanical switch. If the semiconductor switch is electrically nonconductive, the second current path is also nonconductive, and therefore electrical current cannot be conducted over this current path. On the other hand, if the semiconductor switch is electrically conductive, the second current path is electrically conductive, and the electrical current is conducted across the semiconductor switch by means of the switching device.

The switching device can have a drive with a first drive unit and a second drive unit. The two drive units have an electrical design, so that the mechanical switch is driven by energization. It is possible to change the switching state of the mechanical switch when each of the drive units is energized. For example, by use of each of the drive units it is possible to bring the mechanical switch into the open state, in which in particular the movable contact is spaced apart from the associated fixed contact. Operating one of the drive units is in each case sufficient for opening the mechanical switch. For example, by use of the drive units, it is also possible in each case to separately bring the mechanical switch into the electrically closed state. This is preferably possible at least by use of the first drive unit. For example, this is not possible by use of the second drive unit, which simplifies the design.

Each drive unit advantageously can include an electrical coil. During operation of the drive unit a magnetic component, for example a permanent magnet or a ferromagnetic component, is suitably moved within the coil. The same magnetic component is preferably associated in each case with the two drive units, thus reducing material costs and the installation size. The (magnetic) component is advantageously connected to the mechanical switch, preferably to the contact bridge.

The drive can be designed as a moving magnet actuator, for example. The magnetic component, which is movably supported, is also associated with the moving magnet actuator. The moving magnet actuator includes the first drive unit together with one or more electrical coils, and upon energization a magnetic interaction occurs between them and the (magnetic) component. The electrical coils are stationarily mounted. Since the electrical coil(s) is/are stationarily mounted, the design is simplified, and with the exception of the components needed for the support, no further moving parts or electrical connections between the moving parts, namely, the component and the stationary components of the moving magnet actuator (also referred to below merely as an actuator), are required. Friction is also reduced as a result.

The first drive unit can include two electrical coils which are structurally identical, for example. However, the two electrical coils are at least offset relative to one another along a longitudinal axis and situated concentrically with respect to same. The component is situated in particular on the longitudinal axis, and is supported so that it is movable along same. For one switching state of the mechanical switch, the component is situated in an air gap that is present between the two electrical coils, and is held at that location by means of a magnetic short-circuit plate, for example. In contrast, in the other switching state the component is offset along the longitudinal axis.

The second drive unit likewise can include corresponding electrical coils, in particular one of the electrical coils of the first drive unit being surrounded in each case by a respective electrical coil of the second drive unit, so that these coils are situated concentrically with respect to one another. It is thus possible to achieve an electrical interaction with the (magnetic) component also by use of the second drive unit, with the drive being comparatively compact. In addition, the mechanical switch is actuatable separately in each case by means of the two drive units.

Since the number of moving parts of the moving magnet actuator, in particular just the component, is/are comparatively small and in particular has/have a comparatively low weight, the dynamics of the actuator are comparatively high. Inertia during actuation of the mechanical switch is thus reduced. Comparatively fast switching is thus enabled by use of the switching device.

The switching device also can include a control unit. The drive, namely, the first drive unit, can be energized by means of the control unit. In other words, it is possible to energize the first drive unit, in particular an electrical coil associated with the first drive unit, by means of the control unit, for which purpose a voltage is advantageously applied thereto. For this purpose, the first drive unit is in particular electrically connected to the control unit.

For example, by use of the control unit even further functions are taken on, in particular detecting a request to change the switching state of the switching device, for example a request to start or end conduction of the electrical current by means of the switching device. For example, the switching device also performs monitoring of the electrical current conducted by means of the switching device. The control unit suitably has an interface for connection to further components via signal, for example the circuit breaker and/or the circuit that may be present, by using the switching device. In summary, the drive is energized, at least in part, by means of the control unit.

The second drive unit can be switched in particular independently of the control unit, and electrically in parallel to the second current path. Preferably no additional switch or the like is present, so that electrical current flows across the second drive unit if the second current path is electrically nonconductive but the first current path is electrically conductive. By use of the second drive unit an electrical resistance is provided, at least due to the possibly present electrical coil. Thus, if the switching device and therefore also the semiconductor switch are in the electrically conductive state, the electrical current conducted between the terminals is conducted primarily across the semiconductor switch and not, or only to a comparatively small extent, across the second drive unit. The switching device is advantageously designed in such a way that if the semiconductor switch is electrically conductive, the electrical current conducted by means of the second drive unit is not sufficient to actuate the mechanical switch. In other words, by means of the second drive unit a magnetic field is optionally generated which, however, is too weak to move the possibly present magnetic component with respect to mechanical friction of the switch or other forces, for example elastic forces, acting on the mechanical switch.

The switching device can be designed in such a way that the mechanical switch is transferred into the open state when a predetermined electrical current is conducted by means of the second drive unit. In other words, for the predetermined electrical current a sufficiently strong magnetic field is advantageously generated, so that the mechanical switch is opened. In particular, the second drive unit has such a design. The second drive unit is advantageously connected to the second current path in such a way.

The switching device can be designed for a nominal current. In other words, it is possible to conduct an electrical current, up to the level of the nominal current, across the switching device without damage occurring. A time period for which this electrical current can be conducted by means of the switching device is essentially unlimited. For an increased electrical current, for example damage to the switching device occurs, for example immediately or at least after a short period of time. By use of the control unit it is particularly preferably possible to conduct an electrical current that is greater than the nominal current, at least for a period of time which in particular is less than 10 seconds or 5 seconds. On the other hand, if conduction lasts longer, for example damage to the switching device occurs, at least when the electrical current is greater than the nominal current plus a possible tolerance, such as 20%. In other words, it is possible by means of the switching device to conduct overcurrent or short-circuit current, but only for the comparatively short time period, after which destruction or at least a reversible change of the switching device occurs.

Based on the nominal current, it is thus known how the switching device can be used, and the individual components of the switching device are adjusted accordingly. Thus, the manufacturer of the switching device can estimate which components are needed for this purpose. In summary, the mechanical switch and the semiconductor switch are thus designed in such a way that by use of same the nominal current can be conducted for essentially an unlimited period of time. In addition, by use of the second drive unit the nominal current can be conducted for an unlimited period of time.

The control unit, for example, can be designed for the nominal current, and for example is electrically contacted with at least one of the current paths via a current transformer. Thus, by use of the control unit the current is not conducted at the level of the nominal current, but at a reduced level, for which, however, in particular the current transformer is designed. Alternatively, the energization of the control unit takes place by means of a secondary voltage source, in particular via auxiliary terminals. The switching device is advantageously designed in such a way that a voltage of less than 60 volts, in particular 24 V or 12 V, is applied to the auxiliary terminals so that energization of the control unit takes place. For energizing the first drive unit, in particular the voltage present at the auxiliary terminals is applied by means of the control unit.

The predetermined electrical current, which results in actuation of the mechanical switch when the current is conducted by means of the second drive unit, can be less than three times the nominal current. In other words, when the predetermined current is conducted between the two terminals but the semiconductor switch is open, due to the second drive unit the drive is actuated in such a way that the mechanical switch is transferred into the open state. As a result, the electrical current flow across the mechanical switch and therefore also across the switching device collapses. The predetermined electrical current is less than an overcurrent or short-circuit current. In other words, the predetermined electrical current, also referred to merely as predetermined current, is less than the overcurrent or short-circuit current, and the predetermined current is also reached, for example, during normal operation of the switching device, i.e., when no fault, for example in the switching device and/or the circuit in which the switching device is used, is present. In summary, the second drive unit can thus carry the predetermined electrical current, at least for a certain period of time. The second drive unit is suitably designed for the predetermined electrical current or at least for the nominal current.

Based on such an example, it is thus possible to interrupt the electrical current across the switching device in different ways, for example, by direct energization of the first drive unit by means of the control unit. This takes place in particular during normal operation, i.e., when the electrical current is to be interrupted in a desired manner by means of the switching device.

However, if the first drive unit is damaged, the electrical current continues to flow across the first current path and the second current path. In this case it is possible to actuate the semiconductor switch. In this case it is possible to actuate the semiconductor switch, for example, to place it in the electrically nonconductive state, so that the electrical current is no longer conducted across the second current path and is commutated to the second drive unit. Thus, the mechanical switch is still open. As a result, the two terminals are galvanically separated from one another, even if a fault is present in the first drive unit. Safety is thus increased. It is not necessary to provide two mechanical switches, two drives, and two control units. The installation size is thus reduced and manufacturing costs are lowered.

For example, the semiconductor switch can be provided for bidirectional switching. Alternatively, the second current path includes two semiconductor switches which interrupt the electrical current only in one current direction, and which are electrically connected to one another in series but antiparallel. As a result, it is possible, with each of the two semiconductor switches, to interrupt the electrical current across the second current path in each of the two possible current directions. It is thus possible to install the switching device at essentially any desired location and/or also to interrupt a possibly present reverse current when used in a direct current circuit.

The second drive unit preferably can include a rectifier via which the electrical coil(s) is/are electrically contacted with the second current path. This ensures that, due to the electrical coil(s), the electrical current always flows in the same direction, independently of the polarity of the voltage present at the terminals. By use of the second drive unit, the mechanical switch may be transferred at least into the open state.

For example, the second current path includes a rectifier via which the semiconductor switch is electrically contacted with the terminals. The rectifier thus ensures that the electrical current always flows across the semiconductor switch in a single direction, regardless of the direction of the electrical current that is conducted between the terminals. Safety is thus increased, and only one appropriate semiconductor switch is necessary. In this case as well, at least two appropriate semiconductor switches that are electrically connected in series are preferably present. The switching directions of the two semiconductor switches relative to one another are the same. This results in a type of cascode, wherein a reduced voltage is connected by means of each semiconductor switch in order to interrupt the electrical current flow across the second current path. Requirements for the semiconductor switches and therefore also manufacturing costs are thus reduced. The semiconductor switches are advantageously bridged by means of a respective resistor, thus implementing a voltage divider. Alternatively or in combination therewith, the semiconductor switch or the semiconductor switches is/are bridged by means of a respective varistor, so that a maximum voltage applied thereto is limited. As a result, no destruction of the semiconductor switch(es) occurs, even in the event of electrical overvoltage.

For example, the predetermined electrical current is less than twice the nominal current. By use of the second drive unit it is thus possible to conduct an increased electrical current without opening the mechanical switch. However, the mechanical switch is still safely transferred into the open state when an excessively high electrical current is conducted by means of the switching device, in particular of the second drive unit. Alternatively or in combination therewith, the predetermined electrical current is greater than one-half the nominal current. Thus, if only a comparatively low electrical current is conducted by means of the switching device and the semiconductor switch is in the electrically nonconductive state, for example due to a malfunction or delayed activation, the mechanical switch is not actuated. The mechanical switch is actuated in particular only when the electrical current conducted by means of the switching device is comparatively high and could result in damage or undesirable behavior.

The predetermined electrical current is particularly preferably equal to or slightly less than the nominal current. It is thus possible to use the second drive unit to de-energize the switching device, also during normal operation, in particular also when, with the exception of the first drive unit, for example, no other malfunction or fault is present in the circuit in which the switching device is used.

For example, the semiconductor switch is self-conducting or bistable. However, the semiconductor switch particularly preferably has a self-locking design. The semiconductor switch is advantageously an n-channel MOSFET or an IGBT. If no suitable activation of the semiconductor switch takes place or can take place, for example because a malfunction is (also) present in the semiconductor switch, the activator, and/or the activation of the semiconductor switch, the semiconductor switch is automatically transferred into the electrically nonconductive state, so that the electrical current that is possibly conducted between the terminals is subsequently conducted by means of the drive unit, and the mechanical switch is therefore opened. In other words, if the semiconductor switch has a malfunction, the mechanical switch is opened essentially automatically, thus increasing safety. This take place regardless of whether the drive, in particular the first drive unit, also has a malfunction.

For example, the semiconductor switch is operated by means of a separate unit. However, it is particularly preferred for the control unit that also energizes the first drive unit to be used for operating the semiconductor switch. The number of required components is thus reduced. It is also possible in particular, essentially concurrently with the energization of the first drive unit, to also activate the semiconductor switch in such a way that it is transferred into the electrically nonconductive state. For this purpose the first drive unit, the control unit, and the semiconductor switch are advantageously suitably connected to one another, thus reducing effort and complexity. The semiconductor switch suitably has a self-locking design, so that if there is a malfunction or failure of the control unit which also prevents suitable activation of the drive, the second drive unit is actuated so that the mechanical switch is opened.

For example, the switching device is formed essentially solely by use of the control unit, the first current path, and the second current path, in particular by use of the control unit, the semiconductor switch, the mechanical switch, and the drive. However, the second current path particularly preferably includes a current sensor that is electrically connected in series with the semiconductor switch. In particular, the current sensor is designed as a shunt and has a measuring shunt. The semiconductor switch is advantageously connected to the current sensor and the control unit in such a way, or at least the switching device is designed in such a way, that when the first drive unit is energized but the electrical current is still present over the second current path, the semiconductor switch is brought into the electrically nonconductive state. By use of the current sensor, it is thus possible in particular to check whether the mechanical switch has been opened after energization of the first drive unit.

Alternatively or in combination with the current sensor, a signal contact which in particular is forcibly actuated is, for example, connected to or in operative connection with the mechanical switch. It is thus possible in particular to determine a position of the possibly present movable contact relative to the fixed contact. Alternatively or in combination therewith, a voltage sensor or the like is present that detects the voltage applied across the mechanical switch. It is also possible for the voltage sensor to at least determine whether the mechanical switch is open, and in particular whether a malfunction of the first drive unit is present. Multiple monitoring is thus possible concerning whether the switching device is functioning properly, thus further increasing safety.

The second current path can include a fuse that is electrically connected in series with the semiconductor switch. The fuse is in particular a safety fuse. The fuse is advantageously designed in such a way that it is triggered when the predetermined electrical current or a higher electrical current is reached, so that the electrical current across the second current path is interrupted. In summary, in particular the electrical current above which the fuse burns out/triggers is less than the predetermined electrical current. If the electrical current is then commutated to the second drive unit, this is sufficient for the mechanical switch to be opened. Due to the mechanical switch which is then open, the galvanic separation is improved compared to use of just the fuse, for which the burn-off particles that are present continue to allow flow of electrical current.

For example, only the second current path can be electrically connected in series with the first current path. Alternatively or in combination therewith, only the second current path is connected to the second drive unit. However, it is particularly preferred that multiple second current paths are present that are electrically connected to one another and also to the second drive unit in parallel, and thus in series with the first current path. As a result, the electrical current conducted via the first current path is divided over the individual second current paths, thus reducing the electrical current that is conducted via each of the second current paths. Each second current path includes the semiconductor switch, and in particular all semiconductor switches are acted on by a shared control line so that they are always actuated simultaneously. Due to the division of the electrical current over the second current paths, the requirements for the semiconductor switches are reduced, which lowers manufacturing costs in spite of the plurality of semiconductor switches.

If not all semiconductor switches are placed in the electrically nonconductive state, for example due to a further malfunction, the electrical current that is conducted by means of the second drive unit increases when at least some of the semiconductor switches are electrically nonconductive, so that the mechanical switch is opened. Additional redundancy is thus provided and safety is increased.

The respective fuse can also be associated with each second current path, with the triggering threshold for the fuses being adapted to the particular second current path. For example, if the electrical current increases but operation of the first drive unit is no longer possible, at least one of the fuses is triggered. As a result, electrical current can no longer be conducted over this second current path, for which reason the electrical current conducted over the remaining second current paths increases, and the fuses are triggered, at least in succession, for these current paths. This takes place until the predetermined electrical current is conducted by means of the second drive unit, so that the mechanical switch is opened. Safety is thus further increased.

A semiconductor switch can be connected, for example, in parallel to the mechanical switch. In particular, the semiconductor switch is placed in the electrically conductive state before the first drive unit is energized. The electrical current commutates to the further semiconductor switch, which is subsequently placed back in the electrically nonconductive state, namely, when the mechanical switch is already open. Arc-free switching of the switching device is thus made possible.

The method can be used to operate a switching device that is designed for a nominal current, and that includes two terminals which are electrically connected via a first current path and a second current path that are electrically connected in series. The first current path has a mechanical switch, and the second current path has a semiconductor switch. The mechanical switch is driven with a drive having a first drive unit that is energized with a control unit, and having a second drive unit connected in parallel to the second current path. The switching device is designed in such a way that the mechanical switch is transferred into an open state when a predetermined electrical current that is less than three times the nominal current is conducted by means of the second drive unit.

In the method, a request to interrupt an electrical current that is conducted across the switching device is detected by means of the control unit. For example, a connection via signal exists, in particular via an interface, with further components of a circuit in which the switching device is used. The request is particularly preferably provided by use of a higher-level process controller or the like, in particular during normal operation. Alternatively, the request is made, for example, by the control unit itself, for example a separate/different part. Alternatively or in combination therewith, the request is made as a function of measured data of a sensor, advantageously when on this basis a fault such as overvoltage or a short-circuit current has been detected.

After the request is received, the first drive unit is energized by means of the control unit in such a way that the mechanical switch is transferred into the open state, so that the two terminals in particular are galvanically separated from one another. The semiconductor switch is advantageously left in the electrically conductive state, at least initially. The mechanical switch is thus used to interrupt the electrical current, in particular during normal operation. The galvanic separation preferably takes place in the process, thus increasing safety. The method is suitably carried out, at least in part, by use of the control unit. The method is preferably carried out or started when the switching device is energized.

The semiconductor switch is advantageously left in the electrically conductive state after, or at least during, the energization of the first drive unit. It is preferably checked whether the electrical current is still being conducted, preferably after the first drive unit is energized, or at least when this has already taken place for a period of time. A current sensor that is electrically connected in series with the semiconductor switch is advantageously used for this purpose. Alternatively or in combination therewith, it is determined that the electrical current is still being conducted when a signal contact associated with the mechanical switch indicates that the mechanical switch is still closed.

If the electrical current is still being conducted, the semiconductor switch is transferred into the electrically nonconductive state, so that the electrical current that continues to flow between the terminals is conducted by means of the second drive unit. The mechanical switch is correspondingly driven as a result. Thus, safe switching-off occurs when there is a request, even if the first drive unit is faulty. The second drive unit and the semiconductor switch are thus essentially used only when there is a fault in the first drive unit. Their required period of use and therefore also manufacturing costs are thus reduced.

For example, the first drive unit is energized only when there is a request. It is particularly preferred that, independently of the request, the first drive unit is energized by means of the control unit in such a way that the mechanical switch is transferred into the open state. However, this occurs only when a certain condition is present. The certain condition is always present, for example, when a time period longer than 10 minutes, 1 hour, or a day, for example, has elapsed. The time period is advantageously less than 1 month or 1 week. After the first drive unit is energized, a check is made whether the electrical current has been interrupted. If this is the case, the first drive unit is subsequently energized by means of the control unit in such a way that the mechanical switch is once again transferred into the closed state, so that the electrical current is conducted once more by means of the switching device.

Due to interrupting the electrical current flow, a load that is energized across the switching device is thus not energized for a brief period, which advantageously is less than 1 second or 100 ms. When the load has a capacitance, such as a capacitor, this brief drop in the electrical current is intercepted, so that the load may continue to be operated.

If the electrical current continues after the first drive unit is energized, the semiconductor switch is transferred into the electrically nonconductive state, so that the second drive unit is energized and therefore the mechanical switch is opened. In this case, in particular the drive is subsequently blocked and an error message is output. The functionality of the switching device is thus checked, and a fault in the switching device is determined early, in particular before some other malfunction occurs in the possibly present circuit.

The (certain) condition is advantageously present periodically, so that a periodic check is made as to whether fault-free opening of the mechanical switch by means of the first drive unit is possible. As a result, it is determined comparatively early whether a malfunction is present, which increases safety. Alternatively or in combination therewith, the certain condition is met when it has been determined that a malfunction/fault is present.

The switching device is particularly preferably used for interrupting direct voltage and/or direct current. The switching device is advantageously used in a motor vehicle or in an industrial facility. The invention further relates to the corresponding use of the switching device, which preferably is an integral part of a circuit breaker. Moreover, the invention relates to a circuit that includes such a switching device. The circuit advantageously includes a direct voltage source and a load. In particular, the circuit is an integral part of a motor vehicle. The direct voltage source is an energy store, for example, such as a high-voltage battery. Alternatively, the direct voltage source is a rectifier. The load is advantageously an electric motor, or at least a drive that includes the electric motor.

The switching device is advantageously an integral part of a circuit breaker. The first drive unit is suitably operated as a function of a trigger characteristic curve. The mechanical switch is preferably opened by means of the first drive unit when an electrical current has been conducted for a certain period of time that is specified by the trigger characteristic curve. A sensor for detecting the electrical current conducted by means of the circuit breaker is advantageously present. The sensor preferably includes a shunt. The invention further relates to such a circuit breaker.

The refinements and advantages explained in conjunction with the switching device are analogously transferable to the method/the use/the circuit/the circuit breaker and among one another, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a circuit with a load and a switching device,

FIG. 2 shows a simplified circuit diagram of the switching device, and

FIG. 3 shows a method for operating the switching device.

### DETAILED DESCRIPTION

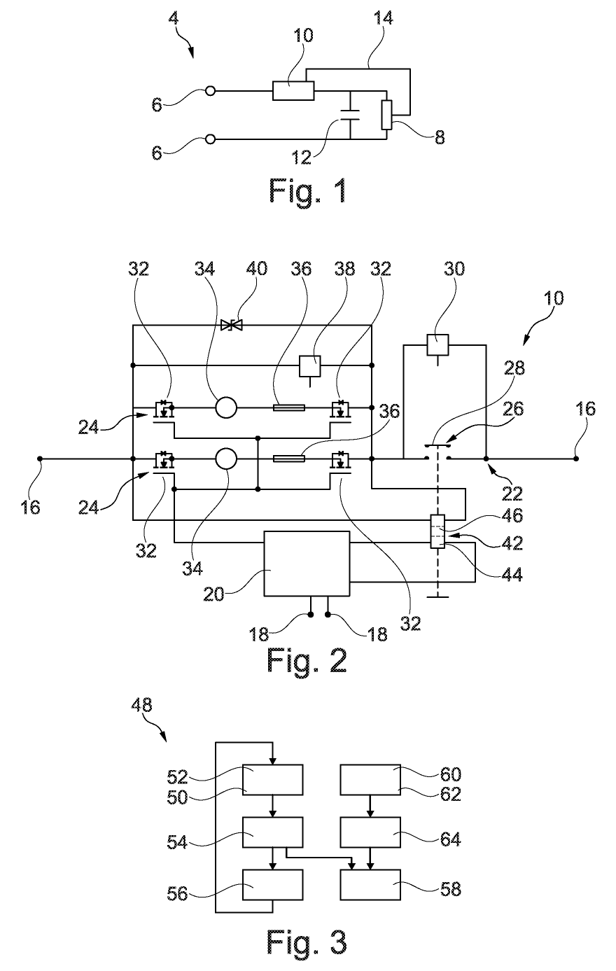

A circuit 2 that includes a direct voltage source 4 with two poles 6 is illustrated in FIG. 1 in a schematically simplified manner. A direct voltage of 650 V is provided by means of the direct voltage source 4; the direct voltage is present between the two poles 6, and feeds a load 8 that is connected to one of the poles 6 via a switching device 10 and is directly connected to the other pole. A capacitor 12 that has an electrical capacitance is connected in parallel to the load 8. The load 8 and the switching device 10 are connected via signal by means of a signal line 14, so that data/information may be exchanged between them.

FIG. 2 schematically shows a simplified circuit diagram of the switching device 10. The switching device 10 has two terminals 16, each of which is connected to a line of the circuit 2. One of the terminals 16 is electrically connected to one of the poles 6 of the direct voltage source 4, and the other terminal is electrically connected to the load 8 and to the capacitor 12. The terminals 16 are introduced into a housing, not illustrated in greater detail, which encloses the further components of the switching device 10.

Also introduced into the housing are two auxiliary terminals 18, which are electrically contacted with a secondary direct voltage source, not illustrated in greater detail. This secondary direct voltage source provides a direct voltage of 12 V or 24 V, which is thus present at the auxiliary terminals 18 during operation. A control unit 20 is electrically contacted with the auxiliary terminals 18, and is thus energized via the auxiliary terminals 18. In addition, the control unit 20 is connected via signal to the signal lines 14 via an interface, not illustrated in greater detail, of the control unit 20.

One first current path 22 and multiple second current paths 24 are connected between the terminals 16, with two such second current paths 24 being included in the illustrated example. The second current paths 24 are electrically connected to one another in parallel. The first current path 22 is electrically connected in series with each of the second current paths 24, and the two terminals 16 are electrically connected to one another by means of the first current path 22 and the second current paths 24. Thus, if an electrical current is conducted across the switching device 10, the current is completely conducted over the first current path 22 and proportionately over each of the second current paths 24.

The first current path 22 has a mechanical switch 26 that is designed as a double interrupter. For this purpose, the mechanical switch 26 includes an essentially linear contact bridge 28 that is supported so that it is movable perpendicularly to its direction of extension. A movable contact is associated with each of the opposite ends of the contact bridge 28; due to the movable support, the contacts can be mechanically placed against an associated fixed contact in each case. In this case the mechanical switch 26 is closed and electrically conductive. It is possible to space the movable contacts apart from the fixed contacts by adjusting the contact bridge 28. In this case the mechanical switch 26 is open and electrically nonconductive.

A first voltage sensor 30 that is connected via signal to the control unit 20 is electrically connected in parallel to the mechanical switch 26, and thus to the first current path 22. By means of the first voltage sensor 30 it is possible to detect the voltage that is present across the mechanical switch 26. If this voltage is negligible, the mechanical switch 26 is closed. On the other hand, if the measured voltage is higher, the mechanical switch 26 is open.

The two second current paths 24 are structurally identical to one another, and each has two semiconductor switches 32 designed as an n-channel MOSFET. The semiconductor switches 32 are thus self-locking, and the semiconductor switches 32 are high-impedance when no electrical potential is present at their gate. The gates of the semiconductor switches 32 are directly electrically connected to one another and to the control unit 20, by means of which the semiconductor switches 32 are thus operated. Due to the electrical connection of the gates, all semiconductor switches 32 are either in the electrically conductive state or the electrically nonconductive state if no fault is present. The semiconductor switches 32 of each second current path 24 are electrically connected in series, with their reverse directions being opposite one another. Thus, if all semiconductor switches 32 are high-impedance, a flow of electrical current over the second current paths 24 is prevented in both current directions.

A current sensor 34 and a fuse 36 are electrically connected in series with the two semiconductor switches 32 of each second current path 24, namely, between same in the illustration. Thus, each second current path 24 includes the current sensor 34 and the fuse 36, which are electrically connected in series with the semiconductor switches 32 of the same second current path 24.

A second voltage sensor 38 and a suppressor diode 40 are in each case electrically connected in parallel to the second current paths 24. The suppressor diode 40 ensures that the maximum voltage across the second current paths 24, which can be measured by means of the second voltage sensor 38, is limited. If the semiconductor switches 32 are electrically conductive, due to the internal resistances of the semiconductor switches 32 the voltage detected by means of the second voltage sensor 38 is comparatively low, with this detected voltage being slightly higher than the voltage detected by means of the first voltage sensor 30.

The switching device 10 also includes a drive 42 with a first drive unit 44 and a second drive unit 46. Each of the drive units 44, 46 includes an electrical coil that is in operative connection with a magnetic component that is attached to the contact bridge 28. The electrical coil of the second drive unit 46 encloses the electrical coil of the first drive unit 44, by means of which the magnetic component is in turn enclosed. Thus, when one of the two electrical coils is energized, in each case the magnetic component is moved and the contact bridge 28 is thus adjusted.

In contrast, the first drive unit 44 is electrically contacted with the control unit 20, so that the first drive unit 44 is energized by the control unit 20. By use of the control unit 20 it is possible to apply the voltage, present at the auxiliary terminals 18, to the first drive unit 44, and the polarity may be changed. It is thus possible, by means of the electrical coil of the first drive unit 44, to move the magnetic component in different directions, so that the contact bridge 28 likewise can be moved in different directions. In other words, it is possible to open as well as close the mechanical switch 26 by appropriate energization of the first drive unit 44 by the control unit 20.

The second drive unit 46 is connected in parallel to the second current paths 24, and has a rectifier via which the electrical coil of the second drive unit 46 is electrically contacted with the ends of the second current paths 24. This ensures that current always flows through the electrical coil of the second drive unit 48 only in a single direction, so that a force can be applied to the magnetic component only in one direction. By use of the magnetic component, only a force that is directed away from the fixed contacts can be applied to the contact bridge 28. In summary, by means of the second drive unit 46 it is possible only to open the mechanical switch 26, i.e., to transfer it into the open state. The rectifier, the design of the electrical coil, and/or a corresponding resistance of the second drive unit 46 ensure(s) that the adjustment of the bridge 28 takes place only when at least one predetermined electrical current is conducted by means of the second drive unit 46. Otherwise, the magnetic interaction between the electrical coil and the magnetic component is too weak.

The switching device 10 is designed for a nominal current of 10 A, for example. The individual components of the switching device 10 are thus designed in such a way that an electrical current of 10 A can be conducted for an essentially unlimited period of time by means of the switching device 10. Due to the parallel connection of the second current paths 26, the required nominal current of the semiconductors 32 is equal to 5A. The fuses 36 are designed in such a way that they trigger at an electrical current of 5 A plus a tolerance of 10%. This ensures that no triggering occurs, even if the electrical current conducted by means of the switching device 10 briefly increases.

The predetermined electrical current above which the mechanical switch 26 is transferred into the open state by means of the second drive unit 46 is equal to the nominal current, and is less than twice the nominal current and greater than one-half the nominal current. In summary, the switching device 10 is thus designed in such a way that the mechanical switch 26 is transferred into the open state when the predetermined electrical current, which is less than three times the nominal current, is conducted by means of the second drive unit 46.

The switching device 10 is operated according to a method 48, illustrated in FIG. 3, that is carried out, at least in part, by use of the control unit 20. The method 48 is started when the load 8 is operated, i.e., during normal operation. In a first work step 50 it is checked whether a certain condition 52 is present. The certain condition 52 is consistently present every 24 hours.

When the certain condition 52 is present, a second work step 54 is carried out. Carrying out the second work step 54 is a function solely of whether the certain condition 52 is present, and is independent of other circumstances. In the second work step 54, the first drive unit 44 is energized by means of the control unit 20 in such a way that the mechanical switch 26 is opened. If this takes place without error, the electrical current conducted between the terminals 16 collapses, and the voltage across the mechanical switch 26 increases, which is detected by means of the first voltage sensor 30. No further electrical current is then measured by the current sensors 34. A redundant check is thus made as to whether electrical current is in fact no longer flowing between the terminals 16.

If this is the case, i.e., if the first drive unit 44 has operated without error, and also if the measured data of the first voltage sensor 30 and of the current sensors 34 correspond to one another and if these sensors operate without error, a third work step 56 is carried out. In the third work step 46 the first drive unit 44 is energized in the reverse direction, so that the mechanical switch 26 is closed. Following the transfer of the mechanical switch 26 into the open state, the first drive unit 44 is thus energized by means of the control unit 20 in such a way that the mechanical switch 26 is transferred back into the closed state, i.e., after the electrical current has been interrupted. The electrical current is thus conducted once again across the switching device 10. However, if no electrical current has been conducted by means of the switching device 10, the load 8 is energized by means of the capacitor 12, so that the desired functionality can still be carried out by means of the load 8. In addition, the time interval between the second and third work steps 54, 56 is selected to be correspondingly brief.

After the third work step 56, the first work step 50 is carried out once again, and it is thus monitored whether the certain condition 52 is once more present, i.e., whether 24 hours have elapsed. The switching device 10 is thus checked daily.

In contrast, if in the second work step 54 the electrical current has not been interrupted and/or the values measured by means of the first voltage sensor 30 and the current sensors 34 do not correspond to one another, for example because no electrical current can be measured by means of the current sensors 34 although voltage is also not measured across the mechanical switch 26 by means of the first voltage sensor 30, a fourth work step 58 is carried out. In this step the semiconductor switches 32 are transferred into the electrically nonconductive state by means of the control unit 20. Due to such activation, all second current paths 24 are now high-impedance, and no electrical current is conducted over the two second current paths 24. If a further malfunction happens to be present, and for example only the semiconductor switches 32 of one of the second current paths 24 are transferred into the electrically nonconductive state, the full electrical current is initially conducted via the other of the two second current paths 24. The fuse 36 is not designed for such a high electrical current n and triggers, so that both second current paths 24 are now interrupted.

As soon as both second current paths 24 are interrupted, the electrical current that continues to be conducted between the two terminals 16 is conducted by means of the second drive unit 46. The mechanical switch 26 is thus opened, and the electrical current completely collapses. In the process, the two terminals 16 are galvanically separated from one another. An appropriate warning is subsequently output, for example by activating an LED or the like. The method 48 is then terminated.

As long as the method 48 is being carried out, a fifth work step 60 is additionally performed, in which it is monitored for whether a request 62 is present. This request is transmitted from the load 8 to the switching device 10 via the signal lines 14, namely, when the operation of the load 8 ends or at least is to be interrupted. The request 62 is made, for example, when the functionality provided by the load 8 is no longer needed, or if a malfunction of the load 8 is present. The switching device 10 is thus also used to provide safety. Via the request 62 it is specified that the electrical current conducted across the switching device 10 is to be interrupted. In summary, in the fifth work step 60 the request 62 to interrupt the electrical current conducted across the switching device 10 is thus detected by means of the control unit 20.

In a subsequent sixth work step 64 the first drive unit 44 is energized by means of the control unit 20. The energization is such that a force is exerted on the contact bridge 28, so that the movable contacts are spaced apart from the fixed contacts. In other words, the first drive unit 44 is energized by means of the control unit 20 in such a way that the mechanical switch 26 is transferred into the open state. It is subsequently checked by the current sensors 34 and the first current sensor 30 whether the electrical current is still being conducted by means of the switching device 10. This is the case, for example, when there is a fault in the first drive unit 44.

In this case, the fourth work step 58 is also carried out, and after the first drive unit 44 is energized the semiconductor switches 32 are thus transferred into the electrically nonconductive state. The second drive unit 46 is then energized, so that the mechanical switch 26 is opened. As a result, reliable interruption of the electrical current is provided, even in the event of a malfunction. Even if there is a fault in the control unit 20 and the semiconductor switch 32 is no longer activated correctly, it is ensured by the self-locking semiconductor switches 32 that the electrical current is then likewise conducted by means of the second drive unit 46, so that the mechanical switch 26 is opened.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A switching device for a nominal current, the switching device comprising:
two terminals that are electrically connected via a first current path and a second current path that are electrically connected in series;
a mechanical switch arranged in the first current path;
a semiconductor switch arranged in the second current path; and
a drive to drive the mechanical switch, the drive having a first drive unit that is energized with a control unit, and having a second drive unit connected in parallel to the second current path,
wherein the switching device is designed such that the mechanical switch is transferred into an open state when a predetermined electrical current that is less than three times the nominal current is conducted via the second drive unit.

2. The switching device according to claim 1, wherein the predetermined electrical current is less than twice the nominal current and/or greater than one-half the nominal current.

3. The switching device according to claim 1, wherein the semiconductor switch has a self-locking design.

4. The switching device according to claim 1, wherein the semiconductor switch is operated by means via the control unit.

5. The switching device according to claim 1, wherein the second current path has a current sensor that is electrically connected in series with the semiconductor switch.

6. The switching device according to claim 1, wherein the second current path has a fuse that is electrically connected in series with the semiconductor switch.

7. The switching device according to claim 1, wherein multiple second current paths that are electrically connected to one another in parallel.

8. A method for operating the switching device according to claim 1, the method comprising:
detecting a request to interrupt an electrical current that is conducted across the switching device via the control unit; and
energizing the first drive unit via the control unit such that the mechanical switch is transferred into the open state.

9. The method according to claim 8, wherein after the first drive unit is energized, the semiconductor switch is transferred into the electrically nonconductive state if the electrical current is still being conducted.

10. The method according to claim 8, wherein, independently of the request, when a certain condition is present the first drive unit is energized via the control unit such that the mechanical switch is transferred into the open state, and wherein the first drive unit is subsequently energized via the control unit such that the mechanical switch is transferred into the closed state if the electrical current has been interrupted, and otherwise, the semiconductor switch is transferred into the electrically nonconductive state.
